(19) United States
(12) Patent Application Publication
(10) Pub. No.: US 2014/0217641 A1
(43) Pub. Date: Aug. 7, 2014

(54) PROCESS FOR THE MANUFACTURING OF A BOARD FOR GLIDING ON SNOW, AND BOARD FOR GLIDING ON SNOW OBTAINED FROM THIS PROCESS

(71) Applicant: SKIS ROSSIGNOL, Saint-Jean De Moirans (FR)

(72) Inventors: Jacky CHRISTOUD, Saint Cassien (FR); Emmanuel CASSIBBA, Sillingy (FR); Jacques LE MASSON, Villaz (FR); Thierry MONNET, Izeaux (FR)

(73) Assignee: SKIS ROSSIGNOL, Saint-Jean De Moirans (FR)

(21) Appl. No.: 14/159,865

(22) Filed: Jan. 21, 2014

(30) Foreign Application Priority Data
Feb. 5, 2013 (FR) 1350964

(51) Int. Cl. B29C 70/48; B29C 37/00

(52) U.S. Cl. CPC B29C 70/48; B29C 37/0025
USPC 264/257

(57) ABSTRACT

Process for the manufacturing of a board for gliding on snow, with the said board including at least one fibrous reinforcement (20) embedded in an acrylic resin, during which one places all the component parts of the board in a mold in order, after closure of the mold, to expose this assembly to pre-determined pressure and/or temperature conditions, characterized by the fact that, before and/or during the subjection to the said pressure and/or temperature conditions, the fibrous reinforcement (20) is impregnated with an impregnation composition including at least 70%, in weight, of alkyl (meth)acrylate.

### TECHNICAL DOMAIN

The invention concerns the technical domain of board sports and, more precisely gliding board sports on snow. More particularly, it concerns a process for manufacturing boards for gliding on snow incorporating composite reinforcements, composed of fibrous layers impregnated with a matrix intended to be polymerized to form a resin.

More specifically, it covers a process in which the matrix chosen to impregnate the reinforcements is based on acrylic compounds more precisely, compounds for which the polymerization takes place after impregnation of the reinforcement.

### PRIOR ART

Generally, boards for gliding on snow incorporate rigid reinforcements that are located either side of a central core, the which reinforcements endow the board with rigidity by virtue of this separation of the neutral fiber.

In particular, these reinforcements can be composed of composite structures that combine one or more fibrous layers immersed within resins that are rigid in the temperature range of usage. The fibrous layers are preferably based on strands of high tenacity, such as, for example, glass, carbon, aramid or even basalt fibers, or are even based on high-performance natural fibers, of which linen can be cited as an example.

The resins employed are generally of thermosetting type, and are frequently based on polymeric compounds of epoxy type. These resins have certain advantages. This is because epoxy resins take the form of compositions including polymeric chains of relatively long length that are in contact with the filaments of strands of the reinforcements. When they are exposed to appropriate temperature conditions, these polymeric chains react with each other within cross-linking reactions that create bridges between the various polymeric chains, thereby ensuring the formation of a particularly rigid network. This cross-linking reaction is irreversible, which makes the rigidity permanent. In practice, this cross-linking reaction takes place in a board production mold, in which all the components of the board's structure have been stacked.

The fibrous layers are impregnated before being put into the mold, so as to be able to batch the optimal proportion of resin and distribute it over the entire surface of the reinforcement. In general, in the so-called “wet” processes, the epoxy resin is in a relatively fast-bonding state before the cross-linking reaction, which makes handling the reinforcement relatively delicate, because it is sensitive to the presence of dust and is quite easily soiled. It is also possible to undertake a first stage of partial cross-linking of the resin after the impregnation of the fibrous layer. This first stage very markedly reduces the fast-bonding character of the resin, which facilitates handling of the reinforcement during placement in the mold.

However, this first partial reaction must be particularly carefully controlled, so that the reinforcement conserves a distortion capability within the mold, during the final forming.

Among the constraints pertaining to the use of this type of resin, there is the need to use relatively high temperatures to trigger the cross-linking between the polymeric chains. Therefore, these processes consume a great deal of energy, and oblige one to choose, for all component parts of the board, materials that are capable of withstanding these high temperatures.

Another problem linked to the impregnation operations is the generation of offcuts from cutting the reinforcements into the shape of the board and, therefore, the wastage of the quantity of resin present in the offcuts.

Another constraint is that the boards thus obtained have a non-recyclable structure because of the irreversibility of the cross-linking reactions allowing one to obtain the thermosetting resin.

In document U.S. Pat. No. 5,544,908, the use of thermoplastic resins is envisioned, notably based on acrylic compounds. The production of such a ski is relatively complex, because it requires the use of layers of composite reinforcement manufactured in a prior stage, enabling one to cause the already-polymerized acrylic resin to penetrate to the heart of the reinforcement layer, under conditions involving the use of solvents that are delicate to handle. In a subsequent stage, it is necessary to inject the core, under pressurized conditions, generally using a very special procedure.

### EXPLANATION OF THE INVENTION

One of the aims of the invention is to provide a process that facilitates production operations for board for gliding on snow, particularly as regards the manufacturing the composite reinforcements. Another aim is to improve the energy efficiency of the board manufacturing process incorporating these reinforcements. An additional aim is to reduce wastage of the materials used. A further aim is to improve the recycling of boards for gliding on snow.

Therefore, the invention concerns a board for gliding on snow manufacturing process that includes at least one fibrous reinforcement immersed in acrylic resin. In this process, in the mold, you have all the component parts of the board so that, after closing the mold, this assembly is subjected to pre-determined pressure and/or temperature conditions acting on all or part of these parts, in order to end-up with the practically-final form of the board.

According to the invention, this process is characterized by the fact that, before or during the subjection to these pressure and/or temperature conditions, the fibrous reinforcement is impregnated with an impregnation composition including at least 70% in weight of alkyle (meth)acrylate.

In other words, the thermoplastic resin, which forms the reinforcement with the fibrous layer, is polymerized during the molding operation, i.e. the polymerization is performed in-situ.

Otherwise put, a composition is deposited on the fibrous reinforcement layer that incorporates (meth)acrylate monomers that polymerize within the fibrous reinforcement under the pressure and temperature conditions. Thus, the fibrous reinforcement is impregnated with the impregnation composition—which is mostly based on monomers—before the start of the polymerization of the monomer initiated by the pressure and/or temperature conditions.

Therefore, the invention allows one to make reinforcements immersed in a thermoplastic resin with a to-the-core impregnation, which procures advantageous mechanical properties in terms of reinforcement of the board. It should be noted that the process according to the invention is distinctly different from impregnation processes employing an already-polymerized thermoplastic resin, because such a resin has a very high viscosity that prevents to-the-core penetration into the fibrous reinforcements, or that necessitates high pressure and temperature conditions that render the process delicate and very costly.

Accordingly, thanks to the very low viscosity of the composition incorporating alkyl (meth)acrylate monomers, the impregnation can be done very easily and with the assurance of having homogeneous impregnation, because of the great ability of this composition to spread within the fibrous reinforcement. Furthermore, the quantity of matrix employed is closely managed and is optimized to obtain the desired percentage of resin, without loss of raw material.

By “composition of alkyl (meth)acrylate”, you should understand compositions in which the monomer can be unique, i.e. in which the alkyl grouping is identical for the monomers, but also compositions that incorporate different monomers, each incorporating different alkyl groupings. The resin thus obtained after polymerization can therefore be a homopolymer or a copolymer.

Advantageously, to obtain polymeric chains allowing the most-effective reinforcement, one should prefer alkyl (meth)acrylates in which the alkyl grouping incorporates carbonated chains including between 1 and 15 carbon atoms, among which can be cited, as a non-limitative example, the methyl, ethyl, s-propyl, i-propyl, s-butyl, i-butyl and t-butyl groupings.

In practice, the minimum quantity of monomer in the impregnation composition can be chosen to constitute a compromise between the volatility of the composition, i.e. its ability to remain within the fibrous reinforcement without evaporating, and the viscosity of the composition ensuring its optimal distribution.

Thus, depending on various factors, among which are the working conditions and the non-monomeric additions to the solution, one can prefer that the overall percentage, in weight, of alkyl (meth)acrylate monomer be greater than 70%, advantageously greater than 80%, and very advantageously greater than 90% or even 95%.

The addition to the monomeric fraction of the composition can include different ingredients, particularly polymeric chains augmenting the overall viscosity.

Preferably, these polymeric chains can be formed from monomers similar to those of the majority fraction of the composition. In other words, these polymeric chains can include a low number of alkyl (meth)acrylate monomers, to form homo-oligomers or co-oligomers of alkyl (meth)acrylate, depending on whether they are composed of monomers of which the alkyl groups are identical or different.

Of course, the impregnation composition can also include other components necessary for the satisfactory accomplishment of the polymerization reaction, particularly radical initiators, principally chosen from among the families of peroxides and azonitriles, such as—for example—azobisisobutyronitrile (AIBN) or benzoyl peroxide (PBO).

In practice, the impregnation composition can advantageously have a viscosity, measured at 25° C., that is between 10 and 5000 centipoises (cP) and, advantageously, between 100 and 1000 cP and, preferably, around 500 cP +/−10%.

This is because, when the viscosity is too low, an excessive fluidity makes operations delicate, with risks of leakage of the composition from the mold. Moreover, evaporation phenomena can occur because of the volatility of the monomers, together with greater shrinkage rates of the material after polymerization. Beyond a higher limiting viscosity, it is considered that the movement of the composition can be slowed, and that it augments the risks of imperfect distribution of the impregnation.

The production of the reinforcement according to the invention can also be combined with the specific possibilities of production of the upper protective and decorative layer of the board.

Thus, in a first form of implementation, the layer of fibrous reinforcement impregnated with the impregnation composition can receive, on its upper face, a sheet of previously-existing thermoplastic material, based on a material chemically compatible with the alkyl (meth)acrylate, to enable an effective adhesion of this sheet, which will be intended to become the board's top protective layer.

Obviously, this sheet of thermoplastic material can be based on acrylic resin similar to that in which the fibrous reinforcement is immersed.

In another form of implementation, it is possible to deposit an excess quantity of impregnation composition above the fibrous reinforcement before closure of the mold. This excess quantity comes into contact with the interior face of the cover of the mold at the time of closure of the mold, such that—after molding—this excess quantity forms the board's top protective layer.

In other words, the composition that impregnates the reinforcement can be of sufficient quantity to polymerize not only the interior of the reinforcement that it impregnates but also above, so as to thus form a layer of thermoplastic resin intimately bound to that of the reinforcement.

In one implementation variant, it is also possible to apply a decorative film above the reinforcement, before depositing the excess quantity of impregnation composition, so as to integrate the board's decor below the layer that will be polymerized.

This film can be of very variable natures. It can notably be unweaned glass or polyester or, preferably, acrylic. It can notably be printed with inks forming decorative motifs. The film can have various geometries. It can notably be solid, or enhanced to allow communication of the impregnation composition between the areas above and below the film, so as to augment the anchoring of the top protective layer. This film can be present on the entire surface of the board, or else can only be present in one or more particular areas.

Different variants of execution of the process can be envisioned.

In a first form of implementation, the fibrous reinforcement can be impregnated after having been placed within the mold, and before the mold is closed. In other words, when the reinforcement is placed within the mold, one places the desired quantity of impregnation composition on top of it, to obtain the composite reinforcement with the desired proportions of fibers and resin.

It should be noted that these operations can take place several times when the board incorporates several reinforcements. Thus, if the board incorporates a fibrous reinforcement above the base and below the core, an initial impregnation can take place before the positioning of the core. The impregnation of the upper reinforcement, located above the core, then takes place in a subsequent stage. It is also possible to mix the impregnations prior to the mold insertion and those occurring directly within the mold.

In another form of implementation, the impregnation can take place when the mold is already closed, by means of injection or infusion techniques. To do this, the mold incorporates openings penetrating through to the interior volume in which the component parts of the board are enclosed.

The impregnation composition can then be injected under pressure, or can be sucked in through other suction openings also penetrating through to the volume within the mold.

### BRIEF DESCRIPTION OF THE FIGURES

The manner of implementing the invention, and the advantages thereby accrued, come to the fore clearly in the description of the implementation methods that follow, with the aid of the appended Figures, in which:

FIG. 1 is a simplified cross-sectional view showing a board for gliding on snow production mold in which the various component parts of the board have been partially stacked, and are shown before closure of the mold;

FIG. 2 is a view similar to FIG. 1, for a variant of the manufacturing process.

Obviously, these diagrams are for illustration purposes only, and are mainly intended to allow understanding of the invention, without necessarily being a representation faithful to reality, notably as regards the dimensions of the various items illustrated.

MANNERS OF IMPLEMENTATION OF THE INVENTION

As already stated, the invention concerns a board for gliding on snow manufacturing process, and can be used without difference for skis, whether they be alpine skis, touring skis or cross-country skis, as well as for surfboards, without any limitation.

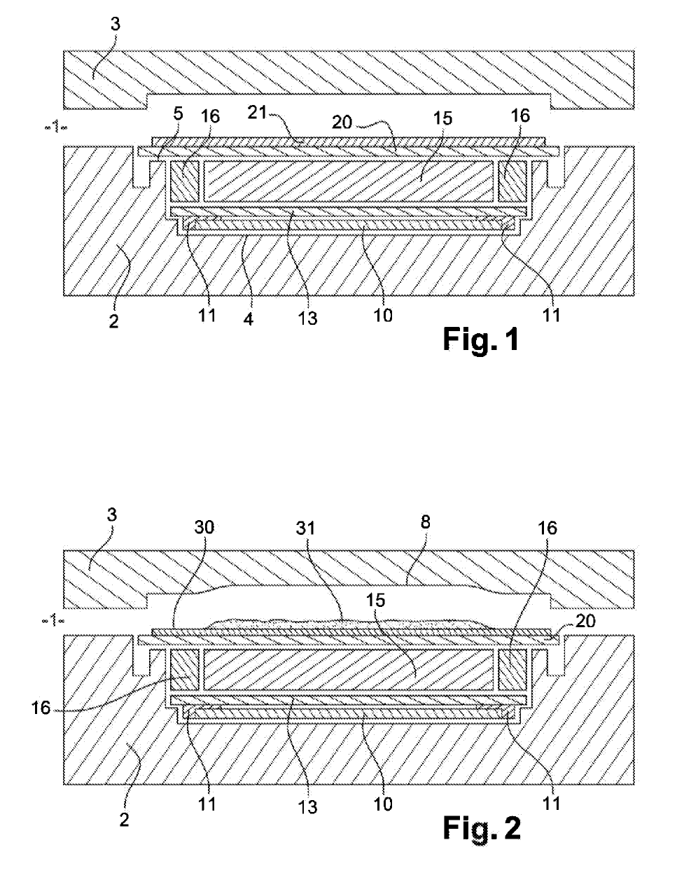

Conventionally, as illustrated in FIG. 1, boards for gliding on snow are formed by molding, in a mold (1) incorporating a bottom (2) and a cover (3). The bottom (2) incorporates a housing (4) within which all the component parts of the board are deposited. The invention is not limited to a type of board structure and, in particular, addresses both structures of sandwich type and structures of shell type. In the form illustrated in FIG. 1, corresponding to a sandwich structure, the mold bottom (2) accommodates a base edged with squares (11), on which an initial reinforcement (13) is deposited.

This reinforcement (13) can be a fibrous reinforcement, in which case the impregnation process of the invention is applied, or else other different reinforcements of metallic or similar type. The fibrous reinforcement can be manufactured in different manners, using various materials, among which one can cite—as examples—glass fiber, carbon fiber, aramid or basalt fiber, or natural fibers such as linen or similar materials.

Neither is the number of reinforcements limited, and it is possible to superimpose several separate layers of identical or different natures and/or geometries.

If the lower reinforcement (13) is of fibrous type, it can accommodate a quantity of impregnation composition, which is deposited on the upper face of the reinforcement, in a continuous fashion or in particular areas, in sufficient quantity to allow the desired impregnation. The lower reinforcement (13) then receives a longilineal component (15) forming the core, with lateral edges (16).

The assembly is then coated with a fibrous layer (20) forming the future upper reinforcement. In the form illustrated, this reinforcement (20) protrudes laterally onto the shoulders (5) of the mold bottom (2), so as to leave this upper reinforcement (20) the ability to distort during the molding. At this stage, as in the case of the lower reinforcement (13), the upper reinforcement (20) receives a quantity of impregnation composition. Of course, other reinforcements—particularly metallic ones—can be added in combination with the lower fibrous reinforcement (13) and/or the upper reinforcement (20).

After impregnation, the upper reinforcement receives a top protective and decorative layer (21). The mold is then closed by bringing the cover and the bottom of the mold into contact, which applies pressure to all the constituent parts enclosed within the mold. The assembly is then brought to a temperature and a pressure allowing the polymerization of the impregnation composition, in accordance with a cycle that is optimized as regards the temperature rise time, the duration of maintenance at constant temperature, and the temperature reduction phase.

During the molding, the upper protective layer (21) and the upper reinforcement (20) adopt the form imposed by the complementary geometries of the mold cover (3) and the core (15), with possible three-dimensional effects.

Because the impregnation composition includes a fraction that is mostly monomers, it deforms easily even at relatively low temperatures.

In a second example of implementation, illustrated in FIG. 2, the various components, i.e. the base (10), the squares (11), the lower reinforcement (13), the core (15), the edges (16), and the upper reinforcement (20)—which is also impregnated—are placed in the mold bottom (2), in a manner similar to the example in FIG. 1.

Afterwards, a film bearing the decorative motifs—which may have been printed, for instance—is deposited on the reinforcement. As previously stated, this film can be present along the entire length of the board, or can only be present in areas of smaller size. Afterwards, a quantity of impregnation composition that forms, before closure of the mold, a kind of dome (31), of which the form depends on the viscosity of the impregnation composition, is placed on top of the film (30). The quantity of material in this layer (31) is sufficient to fill the space present under the lower face of the cover (3), such that the entire lower face (8) of the mold cover comes into contact with the dome (31) when the mold is closed. Thus, during the application of the temperature cycle allowing

the polymerization of the impregnation composition, the excess quantity (31) positioned above the film (30) distorts and becomes rigid, so as to form the board's upper protective layer.

In another variant not illustrated, the manufacturing of the board can be done in such a manner that all the component parts of the board—including the reinforcements of the upper protective layer—are positioned within the mold, which is then closed. This mold is equipped with fully-traversing openings, allowing the insertion—under pressure or through a suction effect—of a quantity of impregnation composition, which then moves, as a function of the pressure field applied, and impregnates the entirety of the fibrous reinforcements. This flowage of the impregnation composition is aided by the low viscosity of the said composition.

As an example, various impregnation compositions can be employed.

A first example of an impregnation composition can be obtained as follows. You dissolve a quantity of solid methyl polymetacrylate (PMMA) in a composition of liquid methyl methacrylate (MMA), such that the MMA is 75% in weight and the PMMA is 25% in weight. This dissolution is obtained through mixture for 48 hours at an ambient temperature of around 25° C. The viscosity of the acrylic impregnation composition thus obtained is around 500 cP (+/−50 cP), as measured at the same ambient temperature of 25° C. A radical initiator is added after complete dissolution, in a proportion of 500 ppm (+/−10%). Different radical initiators can be used, particularly azobisisobutyronitrile (AIBN) or benzoyl peroxide (PBO).

A second example of an impregnation composition can be obtained via a similar procedure, with the sole difference being in the proportions of MMA monomer and PMMA polymer. In this second example, the monomeric fraction is 85% in weight. The viscosity of this composition measured under the same conditions is around 250 cP (+/−50 cP).

The impregnation proportions depend on the nature of the fibers used, and the desired mechanical properties. For example, the ratio of weight of resin to weight of fiber can be approximately 80:20 (+/−10%), which is roughly equivalent—for glass fibers—to a ratio of 30:70 in volume.

With regard to the temperature cycle to be applied, the stabilized temperature range is between 50 and 115° C., and is preferably between 80 and 105° C., or very preferably between 80° C. and 90° C. The duration at this stabilized temperature range is between 5 and 20 minutes, and preferably around 10 minutes.

Of course, multiple variants can be envisioned as long as the principle of the invention is complied with, namely the execution of the methacrylic monomer polymerization operation during the molding operation.

It comes to the fore from the above explanations that the process according to the invention has multiple advantages, among which the following can be cited:

the boards obtained have mechanical properties largely similar to those produced with reinforcements impregnated with thermosetting resin;

the molding temperature necessary for performing this polymerization is considerably lower than the temperature that it is necessary to apply to achieve the cross-linking reaction of thermosetting polymeric resins—typically between 105° C. and 115° C. for epoxy resins. The result is an overall energy saving in the production process;

the molding temperature—which is lower than that observed in equivalent processes using thermosetting resins—also has the advantage of limiting the thermal stresses imposed on the other component parts of the board. In particular, the decorative and protective layers can be chosen in a cheaper material, because no high temperature resistance is required. The fact that these decorative layers do not undergo excessively high temperatures enables them to retain their gloss;

the use of a mainly-monomeric composition—having, therefore, a very low viscosity—allows an impregnation of the fibrous reinforcements directly in the mold, without need to undertake a prior impregnation. Accordingly, the offcuts arising during the cutting of the reinforcements to the shape of the board occur with unimpregnated textiles. Therefore, no impregnation material is wasted at the same time as these textile offcuts.

the acrylic resin obtained by using the impregnation composition according to the invention has a high degree of transparency, which allows one to procure advantageous aesthetic effects: the decorative layers are clearly visible with a high level of detail, and the fibrous reinforcement layers—particularly those that are glass-based—are transparent over their entire thickness;

because of its thermoplastic character, and because of the fact that the polymerization reaction takes place during the molding, it is possible to procure relatively-complex three-dimensional shapes, compared with past art, in which the deformation occurs while the resin is already polymerized within the reinforcement that it impregnates;

the boards for gliding on snow obtained via the process according to the invention are more easily recyclable, because of the thermoplastic nature of the resin impregnating the reinforcements. The materials of the component parts of the board are thus separable by application of a reasonable temperature, close to 150° C., and can be recovered individually. One should also note that the polymerization reaction is itself reversible, since an exposure of the acrylic resin to a temperature of around 400° C. enables the polymeric chain to be decomposed into original polymers. Thus, the impregnation matrix obtained is then reusable.

1. A process for manufacturing a board for gliding on snow, said board including at least one fibrous reinforcement embedded in an acrylic resin, said process comprising:
placing component parts of the board in a mold to form an assembly;
closing the mold; and
after closing the mold exposing the assembly to pre-determined pressure and/or temperature conditions: and
before and/or during the exposing the assembly to the said pressure and/or temperature conditions, impregnating the fibrous reinforcement with an impregnation composition comprising at least 70%, in weight, of alkyl (meth)acrylate.

2. The process according to claim 1, wherein the alkyl (meth)acrylate comprises monomers having an alkyl grouping containing 1 to 15 carbon atoms.

3. The process according to claim 2, wherein the alkyl grouping of the alkyl (meth)acrylate monomers is selected from: methyl, ethyl; s-propyl, i-propyl, t-butyl; s-butyl, and i-butyl.

4. The process according to claim 1, wherein the impregnation composition includes at least 70%, in weight, of methyl methacrylate (MMA).

5. The process according to claim 1, wherein the impregnantion composition includes alkyl (meth)acrylate homo-oligomers and/or co-oligomers.

6. The process according to claim 1, wherein the impregnation composition has a viscosity, at 25° C., of 10 cP to 5000 cP.

7. The process according to claim 1, further comprising, prior to closing of the mold, disposing a sheet of thermoplastic material on the upper face of the fibrous reinforcement.

8. The process according to claim 7, wherein the sheet of thermoplastic material comprises an acrylic resin.

9. The process according to claim 1, further comprising, prior to closing the mold:
depositing an excess quantity of impregnation composition above the fibrous reinforcement,
wherein, during said closing the mold, at least a portion of the said excess quantity of impregnation composition is contacted with an interior face of a cover of the mold, such that, after molding, the said excess quantity forms the board's outer protective layer.

10. The process according to claim 9, further comprising, before said depositing the excess quantity of impregnation composition above the fibrous reinforcement:
placing a decorative film on top of the reinforcement.

11. The process according to claim 1, wherein the fibrous reinforcement is impregnated with the impregnation composition before the fibrous reinforcement is placed in the mold.

12. The process according to claim 1, wherein the fibrous reinforcement is impregnated with the impregnation composition after the fibrous reinforcement is placed in the mold and before closing the mold.

13. The process according to claim 1, wherein said impregnating comprises, after closing the mold, inserting the impregnation composition through one or more openings penetrating through to the interior volume of the said mold.

14. The process according to claim 7, wherein said impregnating comprises sucking the impregnation composition through one or more openings penetrating through to the interior volume of the mold.

15. A board for gliding on snow obtained through the process according to claim 1.

16. The process according to claim 6, wherein the impregnation composition has a viscosity, at 25° C., of 100 cP to 1000 cP.

17. The process according to claim 16, wherein the impregnation composition has a viscosity, at 25° C., of around 500 cP.

18. The process according to claim 1, wherein the board is a ski.

19. The process according to claim 1, wherein the board is a snowboard.
